(19) United States
(12) Patent Application Publication
(10) Pub. No.: US 2009/0030885 A1
(43) Pub. Date: Jan. 29, 2009

(54) METHOD AND SYSTEM FOR ON-DEMAND AND SCHEDULED SERVICES RELATING TO TRAVEL AND TRANSPORTATION

(75) Inventors: Thomas A. DePasquale, Alexandria, VA (US); Irakly G. Areshidze, Washington, DC (US); Keith Forsythe, Alexandria, VA (US); Tobias D. Russell, Washington, DC (US); E. Sanders Partee, Alexandria, VA (US)

Correspondence Address: MCGUIREWOODS, LLP, 1750 TYSONS BLVD, SUITE 1800, MCLEAN, VA, 22102, US

(73) Assignee: RideCharge, Alexandria, VA (US)

(21) Appl. No.: 12/180,086

(22) Filed: Jul. 25, 2008

Related U.S. Application Data
(60) Provisional application No. 60/962,011, filed on Jul. 26, 2007.

(51) Int. Cl. G06F 17/30; G06F 9/46; G06Q 10/00; G06Q 20/00

(52) U.S. Cl. 707/3; 718/102; 705/30; 705/44; 705/7; 707/E17.014

(57) ABSTRACT

A system and a method for providing a user with an ability to manage an on-demand or scheduled service, the system including a mobile communicator configured to receive instructions from the user and to send user data; and a facilitator configured to receive the user data and to retrieve options data based on the user data, wherein the facilitator is further configured to: filter the options data based on an identification data, provide associated costs and relevant information for the filtered options data, and send the filtered options data and the associated costs to the mobile communicator.

### CROSS REFERENCE TO PRIOR APPLICATIONS

This application claims priority and the benefit thereof from U.S. Provisional Application No. 60/962,011, filed on Jul. 26, 2007, which is hereby incorporated by reference for all purposes as if fully set forth herein.

### BACKGROUND

1. Field

A method and a system for on-demand services relating to travel or transportation. More particularly, a method and a system for providing users with finding, selecting, booking, paying, electronically documenting and other functionality related to use of a wide array of goods and services relating to travel or transportation, as well as an ability to share information and collaborate with other users.

2. Related Art

Procurement and tracking of travel, entertainment and related services can be substantially improved by using modern technologies such as the Internet, mobile technology, GPS and other information technologies. Users such as travelers require the ability to search for, exchange information about, reserve, pay for, document and use other functionalities related to goods, services, information or other needs. Many areas, for example, ground transportation, have not benefited from the use of these technologies for activities such as booking reservations, completing payments or account tallies, or documenting payment.

For example, in the on-demand ground transportation space, three main methods may be used for booking, including: 1) directly booking with an individual provider (usually by a phone call); 2) using a travel agent or a provider in one city to create a booking with a provider in another city; or 3) using a pre-paid web booking tool (in very limited circumstances).

Directly booking with an individual provider is difficult, for example, for a user such as a business traveler, who is unlikely to be familiar with the various options for on-demand transportation in a given location, including which provider is most likely to provide reliable service, and the pricing associated with the various options available through the provider. Moreover, the user making the reservations directly with the provider may not take advantage of innovative technologies such as the Internet to manage ground transportation needs. Direct bookings do not allow for comparisons and may not be easily updated or changed as they are each managed on an individual basis through a live phone call with the provider. Additionally, the lack of automation may result in human error and high costs, which are a major drawback of the telephone-dependent direct reservation system.

At the same time, travel agents have generally been hesitant to take responsibility for on-demand transport bookings. When travel agents do offer ground transport bookings, they have tended to charge high fees and offer relatively high-end bookings (such as, e.g., sedans and limos) rather than a full spectrum including taxi, shared ride, sedan, shuttle bus, etc. Provider networks, like those run by certain large city-based fleets, have had some of the same drawbacks, including high costs and limited selection. Online booking tools too have offered limited selection, e.g. sedan, taxi or shared ride only, and have been pre-pay models, leaving the user with little or no flexibility. Furthermore, online booking tools require a computer and Internet access. They do not provide the user the mobile capability to book and update rides ‘on the fly’ or while traveling.

Additionally, in the ground transportation space, three main methods for alternatives to cash payment may be used, including paper vouchers, in-car credit card swipes, and pre-payment/pre-negotiated rates. Paper documentation is unwieldy and expensive. Credit card swipes have met resistance by drivers, and where drivers have handled credit cards, they have been a source for credit card theft. Pre-payment is inaccurate, costly to reconcile, often rejected by drivers and users alike.

The issues experienced in on-demand ground transportation equally apply to other areas of transportation, navigation and related goods and services. These may include aircraft, rental vehicles, parking services, public transport, trains, boats or cruises, entertainment (including movies or shows), meals, lodging, incidentals, financial services, shared/collaborative services, or other goods or services. Users such as travelers seek electronic methods of booking, paying, electronically documenting and other functionality related to their use of a wide array of these goods and services, as well as the ability to get information from and collaborate with others in doing so.

### SUMMARY

In one aspect of the invention, a system is provided that provides a user with an ability to manage an on-demand or scheduled service. The system comprises a mobile communicator configured to receive instructions from the user and to send user data; and a facilitator configured to receive the user data and to retrieve options data based on the user data, wherein the facilitator is further configured to: filter the options data based on an identification data, provide associated costs and relevant information for the filtered options data, and send the filtered options data and the associated costs to the mobile communicator.

The identification data may be one of a user identification data or a mobile communication device identification data. The facilitator may be further configured to: receive option selection data from the mobile communicator and send a request to a provider; receive a confirmation notice from the provider; or to send a confirmation notice to the mobile communicator. The facilitator may comprise at least two of: a search engine including selection rules; a pricing engine configured to determine cost information based on the options data; a payment processing engine configured to process a payment or a promise to pay; a documentation engine configured to provide documentation information; a cashiering engine configured to total an amount due for a transaction, charge the user for the amount due and collect payment for the transaction; a reconciliation engine configured to compare multiple records and to ensure that a charge associated with the transaction matches an actual cost for the transaction; an account management engine configured to manage account information, including a user profile, a goods provider profile, or a service provider profile; and an expense management system engine configured to provide direct or indirect processing, payment, and auditing of user-initiated expenses.

The mobile communicator may be further configured to communicate price comparison information to the user, the communicator comprising: a search engine including selection rules; and an interface configured to receive an instruction from the user.

The facilitator may be further configured to automatically reserve a service based on the received user data. The service may include a travel service, the travel service comprising at least one of a taxi, a sedan, a chauffeured hourly limousine, a shared ride, a shuttle bus, a rental car, a parking or a flight.

The pricing comparison information may comprise pricing between travel goods and service options selected from different service types. The different service types may comprise: ground transportation; water transportation; and air transportation. The price comparison information may comprise at least one of an availability, a type, a cost, a user rating or a recommendation regarding a good or a service.

The mobile communicator may further comprise an itinerary builder configured to receive and display, build and manage, and/or request changes to a full itinerary, including air, hotel, rail, rental car, dining, entertainment and ground transportation, goods and service types, and appointment plans.

The confirmation notice may include a confirmation of a scheduling of a delivery of a good or a service by the provider.

The facilitator may be further configured to: apply a corporate rule to a good or a service option; automatically reserve the service without prepaying for a good or a service; or accurately prepay for a good or a service.

The instruction may comprise an instruction to pay for a good or a service substantially immediately after completion of delivery of the good or the service. The instruction may comprise an instruction to pay for a good or a service received during delivery of the good or the service.

The facilitator may be further configured to: provide payment verification information to the provider without communicating sensitive information, the sensitive information comprising at least one of a credit card number or a physical signature; or electronically document at least one of an amount paid, an amount owed, or an amount used.

According to another aspect of the invention, a method is provided for managing an on-demand or scheduled service. The method comprises: receiving user data from a mobile communicator; retrieving options data based on the user data; filtering the options data based on an identification data; determining associated costs for the filtered options data; and sending the filtered options data and the associated costs to the mobile communicator. The identification data may be one of a user identification data or a mobile communication device identification data.

The method may further comprise: receiving option selection data from the mobile communicator; and sending request data to a provider. The method may still further comprise: receiving a confirmation notice from the provider; or sending a confirmation notice to the mobile communicator.

The method may also comprise: searching for a good or a service based on the user data, wherein the searching is based on selection rules; retrieving information relating to the good or the services from at least one provider; determining cost information associated with the good or the services; and providing pricing information to the mobile communicator, the pricing information being based on the determined cost information.

The method may further comprise: receiving at least one of a goods request, a service request or an option request from the mobile communicator; reserving delivery of the good or the service from the at least one provider based on the at least one of the goods request, the service request or the option request; determining an amount due for the good or the service; charging a user account for the amount due; and collecting payment from the user account.

The method may further comprise: processing a payment or a promise to pay; and documenting at least one of the amount due, the charging the user account and the collecting payment from the user account, the documenting comprising generating documentation information.

The method may comprise: comparing multiple records to ensure a charge associated with the amount due matches an actual cost for the goods or the service; or managing account information, including a user profile, a goods provider profile or a service provider profile; or providing direct or indirect processing, payment and auditing of user-initiated expenses to an expense management system. The service may include a travel service, the travel service comprising at least one of a taxi, a sedan, a chauffeured hourly limousine, a shared ride, a shuttle bus, a rental car, a parking and a flight. The pricing information may comprise comparison pricing between travel goods and service options selected from different service types. The different service types may comprise: ground transportation; water transportation; and air transportation. The pricing information may comprise at least one of an availability, a type, a cost, a user rating or a recommendation regarding the good or the service.

The method may further comprise: building an itinerary, including ground transportation, a good or a service type, and an appointment plan; or confirming a scheduling of delivery of a good or a service by a provider. The filtering may comprise applying a corporate rule to a good or a service option. The reserving the good or the service may be performed without prepaying for the good or the service.

The method may further comprise accurately prepaying for a good or a service. The user data may comprise an instruction to pay for a good or a service substantially immediately after completion of delivery of the good or the service. The user data may comprise an instruction to pay for a good or a service received during delivery of the good or the service.

The method may further comprise: providing payment verification information to the at least one provider without communicating sensitive information, the sensitive information comprising at least one of a credit card number or a physical signature; or electronically documenting at least one of an amount paid, an amount owed, or an amount used.

The method may further comprise: monitoring a status of the delivery of the good or the service; and intervening when an error status is determined. The intervening may comprise: contacting the mobile communicator; or contacting the at least one provider. The instruction may be based on a GPS signal or a Bluetooth signal.

Additional features, advantages, and embodiments of the disclosure may be set forth or apparent from consideration of the following detailed description, drawings, and claims. Moreover, it is to be understood that both the foregoing summary of the disclosure and the following detailed description are examples and are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system for on-demand and scheduled services (SOSS), according to an aspect of the disclosure;

FIG. 2 shows an example of a conceptual configuration of an on-demand and scheduling services computer (OSSC), according to the disclosure;

FIG. 3 shows an example of an SOSS process, according to the disclosure;

FIG. 4 shows an example of an itinerary builder process that may be used with the SOSS system and process, according to the disclosure; and

FIG. 5 shows an example of an application of the itinerary builder process of the itinerary builder process, according to the disclosure.

### DETAILED DESCRIPTION

The embodiments of the disclosure and the various features and details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure teaching principles of the disclosed embodiments. The examples used herein are intended merely to facilitate an understanding of ways in which the disclosure may be practiced and to further enable those of skill in the art to practice disclosed the embodiments. Accordingly, the examples and embodiments herein should not be construed as limiting. Moreover, it is noted that like reference numerals represent similar parts throughout the several views of the drawings.

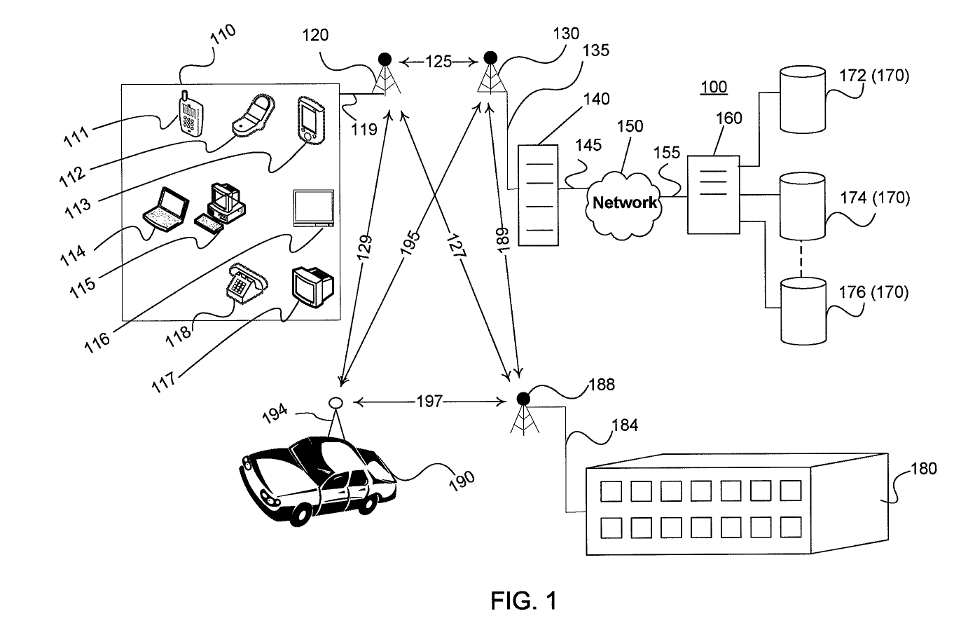

FIG. 1 shows an example of a system for on-demand and scheduled services 100 (SOSS), according to an aspect of the disclosure. The SOSS 100 may include a user communication interface (UCI) 110, a computer 140, a network 150, an on-demand and scheduled services computer (OSSC) or facilitator 160, a goods/service provider 180 and a service provider 190.

The user communication interface (UCI) 110 may include any one or more of, for example, a smart phone 111, a mobile telephone 112, a personal data assistant 113, a portable computer 114, a stationary computer 115, a vehicle computer 116, a television device 117, a household or office telephone 118, or the like. The devices 111-118, each of which may include a computer or a mobile computer, may be coupled to each other through a communication medium in the UCI 110, such as, e.g., a network (not shown). The UCI 110 may be connected to a transceiver 120 through a communication medium 119. Information may be bidirectionally communicated to or from the UCI 110 (including any one or more of the devices 111-118) through the transceiver 120 and any one or more of transceivers 130, 188 or 194, via any one or more of communication media 125, 127 or 129, respectively.

Additionally (or alternatively), each of the devices 111-118 in the UCI 110 may include a transceiver (not shown) for bidirectionally communicating information. In this regard, information may be bidirectionally communicated from (or to) any one or more of the devices 111-118 to (or from) any one or more of the transceivers 130, 188 or 194, directly via any one or more of the communication media 125, 127 or 129, or through an intermediary device, such as, for example, a satellite, an access point, or the like.

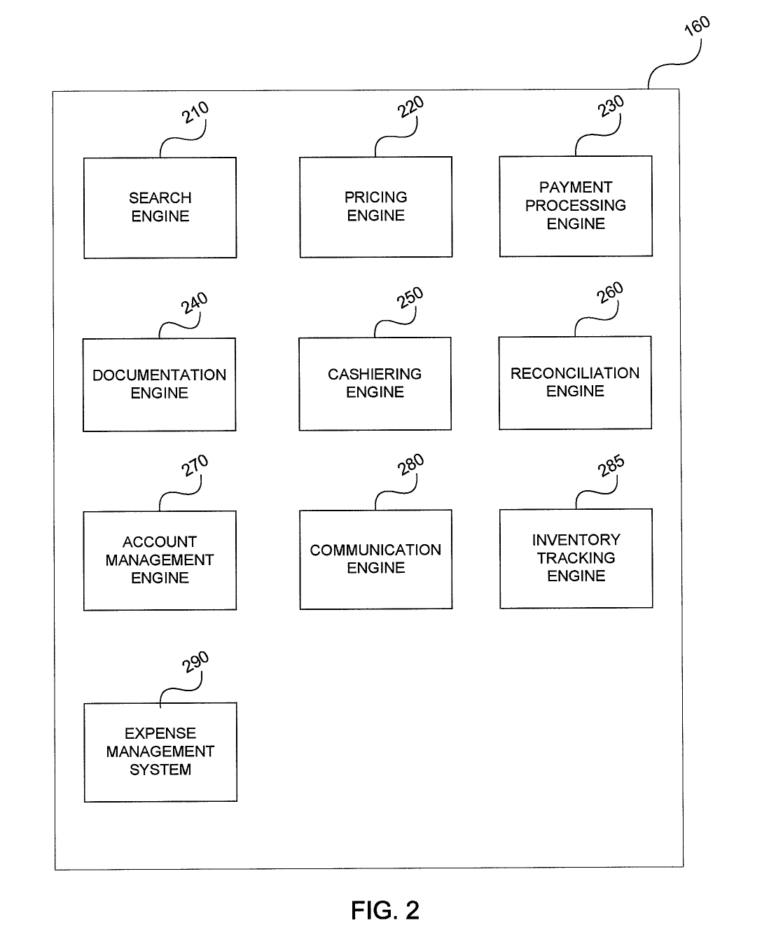

The transceiver 130 may be connected to the computer 140 through a communication medium 135. The computer 140 may be connected to the network 150 through a communication medium 145. The on-demand and scheduled services computer (OSSC) 160 may be connected to the network 150 through a communication medium 155. The OSSC 160 may be connected to a plurality of data storages 170, including, but not limited to, e.g., a user profile and account database 172, a service provider database 174, a goods provider database 176, or the like. FIG. 2 shows an example of a conceptual configuration of the OSSC 160, according to the disclosure.

As seen in FIG. 2, the OSSC 160 may include, for example, a search engine 210, which may include selection rules; a pricing engine 220 configured to determine costs and to present the determined costs along with other information; a payment processing engine 230 configured to process a payment, a promise to pay, a tally, or the like; a documentation engine 240 configured to provide documentation relating to a user transaction, including, e.g., a transaction with a particular goods provider or service provider; a cashiering engine 250 configured to total an amount due for a particular transaction, charge the particular user for the amount due and collect payment for the goods or services exchanged; a reconciliation engine 260 configured to compare multiple records and to, e.g., ensure that the charges associated with a particular user transaction match the actual cost for the particular transaction; an account management engine 270 configured to manage account information, including profile information, for each user, each goods provider, each service provider, and the like; a communication engine 280 configured to manage communication of information within the OSSC 160 and outside the OSSC 160, including initiating sessions, maintaining sessions, terminating sessions, and the like; an inventory tracking engine 285 configured to track inventory, including, but not limited to, location information for a particular user, goods provider, service provider, good, and the like; and an expense management system engine 290 configured to provide direct or indirect processing, payment, and auditing of user-initiated expenses.

Referring to FIG. 1, the goods/service provider 180 may bidirectionally communicate information with any one or more of the UCI 110, the computer 140, the OSSC 160, or the service provider 190 through any one or more of the communication media 127, 189, or 197. For example, the goods/service provider 180 may bidirectionally communicate information via the communication media 127, 189, or 197, by bidirectionally communicating the information through a communication medium 184 and a transceiver 188.

The service provider 190 may bidirectionally communicate information with any one or more of the UCI 110, the computer 140, the OSSC 160, or the goods/service provider 180 through any one or more of the communication media 129, 195, or 197. For instance, the service provider 190 may bidirectionally communicate information via the communication media 129, 195, or 197 by bidirectionally communicating the information through a transceiver 194. The communicated information may include updates from the service provider 190 such as, for example, location information, estimated time of arrival (ETA), traffic conditions, driver name, cab number, or the like.

Further, the goods/service provider 180 may receive transaction data from the service provider 190 regarding a particular transaction. The transaction data may be communicated to the OSSC 160, which processes the transaction data and communicates information associated with the transaction data to the UCI 110.

For example, a taxi (service provider 190) equipped with an electronic card reader, or the like, may pick up a customer having a UCI 110 who provides an electronic payment (such as, e.g., by swiping a credit card through the electronic card reader, or other electronic payment method). The electronic payment information may be captured and communicated from the taxi (service provider 190) to an electronic payment vendor, such as, a credit card vendor or dispatcher (goods/service provider 180) as transaction data, which may include a credit card number, time, GPS location, driver name, cab number, closeout data (such as, e.g., for an electronic expense report), or the like. The electronic payment vendor (goods/service provider 180) may then communicate the transaction data to the OSSC 160. Alternatively, the transaction data may be communicated directly to the OSSC 160 from the taxi (service provider 190). The OSSC 160 processes the received transaction data to generate information associated with the particular transaction data, including the credit card number, the GPS coordinates for the taxi's location, the time of transaction, the driver's name, the relevance or position of the transaction in an itinerary associated with the particular customer or UCI 110, and the like. The OSSC 160 then communicates the information associated with the transaction data to the UCI 110.

Additionally, the customer having the UCI 110 may hail the taxi (service provider 190) for a ride. The customer may communicate information regarding the ride to, for example, an on-board computer in the taxi (service provider 190) and/or to the electronic payment vendor or dispatcher (goods/service provider 180) by entering data to the UCI 110 (or automatically retrieving previously stored data in the UCI 110), such as, for example, a taxi identification number, an amount to be paid for the ride, an amount to be paid as a tip, a credit card number, time, GPS location, driver name, cab number, destination address, route preference, and/or the like. The entered data is captured and communicated from the taxi (service provider 190) to an electronic payment vendor, such as, a credit card vendor or dispatcher (goods/service provider 180) as transaction data. The electronic payment vendor (goods/service provider 180) may then communicate the transaction data to the OSSC 160. Alternatively, the transaction data may be communicated directly to the OSSC 160 from the taxi (service provider 190) or the UCI 110. The OSSC 160 processes the received transaction data to generate information associated with the particular transaction data, including the credit card number, the GPS coordinates for the taxi's location, the time of transaction, the driver's name, the relevance or position of the transaction in an itinerary associated with the particular customer or UCI 110, and the like. The OSSC 160 may then communicate the information associated with the transaction data to the UCI 110, including incorporating the information into an on-board itinerary in the UCI 110. The OSSC 160 may authorize payment to the taxi (service provider 190) by the electronic payment vendor or dispatcher (goods/service provider 180) for the ride. Alternatively, the OSSC 160 may electronically transfer funds from an account associated with the particular customer or UCI 110 to an account associated with the particular taxi (service provider 190) for an amount entered by the customer using the UCI 110.

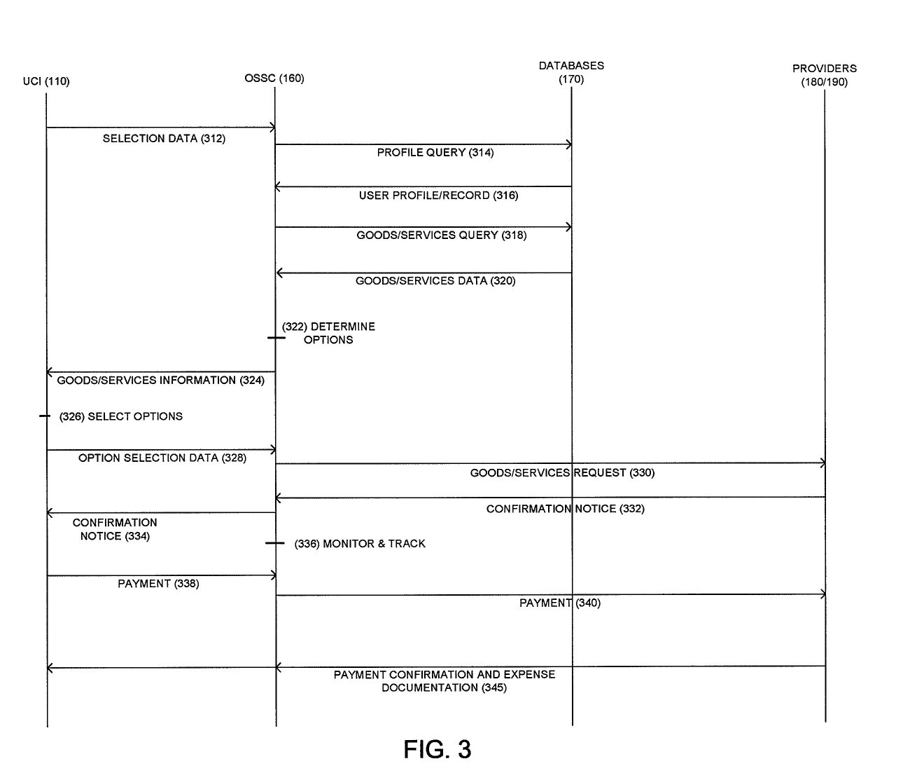

Initially, a user may download an SOSS application to the UCI 110, which may include one or more of the devices 111-118. The SOSS application may include one or more code sections that, when executed by a computer, cause an SOSS process to be carried out, e.g., as described below with reference to FIG. 3. The SOSS application may be accessed through, e.g., a user agent application such as, but not limited to, a web browser, which may include, e.g., Netscape, Internet Explorer, Mozilla Firefox, Safari, Opera, Flock, AOL Explorer, or the like.

The UCI 110 may be equipped with the SOSS application by a manufacturer (such as, for example, Blackberry®, or the like) or by an entity (such as, for example, a corporation, or the like), using, for example, Blackberry Enterprise Server Push, or the like.

Further, the SOSS application may include any one of a plurality of communication methods, including a text messaging (e.g., SMS) sequence, a DTMF tone, a broadcast message, an instant message, an email, a voice call, or the like. The SOSS application may also include rules and functions such as, e.g., for a user to: electronically create reservations for travel services, including ground transportation (such as taxi, sedan, chauffeured hourly limo, shared ride, shuttle bus, etc.), daily or hourly rental cars, parking services, flights (such as air taxis or other private or shared planes), and other travel goods and services; electronically compare pricing between travel goods and service options, both within and across service types (e.g. in ground transportation compare options such as such as taxi, sedan, chauffeured hourly limo, shared ride, shuttle bus, rental car, parking, public transportation, etc.); compare goods and service options using relevant criteria, including availability, type, cost, user ratings and other information; build and manage a full itinerary, including ground transportation and other goods and service types, according to changing travel and appointment plans within and across multiple locations (such as, e.g., cities, counties, states, countries, or the like); receive accurate and comprehensive ground navigation information, including desired locations, purchase and manage goods or services, etc.; receive reminders related to goods or services; make, submit, seek, or receive recommendations, ratings or other information about goods or services, including information that may be presented to future users; apply corporate rules to goods or service options; complete reservations without pre-paying for the goods or services; accurately pre-pay for goods or services; pay electronically for a travel service or good, such as, for example, a trip in a taxi, sedan, limo, shared ride, or the like, immediately at the end of, or during a ride; electronically pay actual charges for services or goods, rather than estimates; to receive verification from, e.g., an operator of a transportation vehicle or other vendor to verify that payment has been made, without handling any sensitive information (e.g. a user's credit card, a physical signature, or the like); electronically document amounts paid, owed, used and other information or functions that facilitate the recording and manipulation of data for users, operators, and others; or the like.

The SOSS application may be provided at a centralized location, such as, e.g, the computer 140 or the OSSC 160, without having to download the SOSS application to the UCI 110. The SOSS application may be executed on the computer 140 or the OSSC 160 using the UCI 110 as an interface through a communication methodology such as, for example, remote procedure call (RPC) messaging.

The SOSS 100 may provide a user with a centralized system that may be used to connect multiple types of tools (such as, e.g., the devices 111-118), which may be accessible to the user, to access goods/service providers 180 and/or service providers 190. The SOSS 100 may allow the user to connect to the goods/service provider 180 or service provider 190 and access those goods or services the user desires or needs. The SOSS 100 provides for effective, efficient, accurate and secure transactions across the system, including searching for goods or services, comparing goods or services, selecting goods or services, negotiating purchases of goods or services, procuring goods or services, delivering goods or services, paying for the goods or service, documenting transactions relating to goods or services, and the like.

For example, the SOSS 100 may provide for mobile electronic payment of actual fares, with messaging to drivers, but no reliance on driver action. The mobile electronic payments may be used to generate trusted, verifiable e-receipts that may be inserted directly into expense management systems, or used to produce tamper-proof electronic files that may be analyzed and manipulated easily.

The SOSS 100 may be equally used in various areas of transportation, navigation and related goods and services. These may include, e.g., aircraft, rental vehicles, parking services, public transport, trains, boats or cruises, entertainment (including movies or shows), meals, lodging, incidentals, financial services, shared/collaborative services, or other goods or services.

When the OSSC 160 receives a goods or services request, it may initiate a communication sequence with the user through the UCI 110. The OSSC 160 may send a communication to the UCI 110 indicating that it has received a request. The OSSC 160 may send reminders to the UCI 110 about upcoming delivery of goods or services, about service disruptions, or provide other information related to the user's request. The reminders may include real-time updates from the inventory tracking engine 285 (shown in FIG. 2) about, e.g., vehicle location, estimated time of arrival, traffic conditions, or the like. Preference tools may be provided to allow the user to determine the timing, form, and other parameters related to the communications. The form of the communications may include, for example, email, SMS, calendar appointments, voice phone calls and/or the like.

When a goods or services request is made from a particular UCI 110 or a particular user, the OSSC 160 may populate a log for the user to monitor the status, timing and other elements related to the request, or to modify, delete, or perform other functions related to the request. This log may be made available to the user on the UCI 110, a web application, in an email, in an instant message, in an SMS message, over the phone, or the like. The log may be edited through any of these means through the UCI 110, and the log may be synchronized between the OSSC 160 and the UCI 110. Additionally, the request log may include information about the goods/service provider 180 and/or the service provider 190, details of the request, or the like. For example, in transportation, the log may include the contact information for the goods/service provider 180 and/or the service provider 190, such as, e.g., a telephone number, an address (e.g., physical address, geographic coordinates address, email address, website address, device address, or the like), a name, a point of contact, or the like, and the OSSC 160 may initiate a call or other direct connection between the user and the goods/service provider 180 and/or the service provider 190, including a conference call or a virtual online meeting. Further, the log may include other information pertaining to the goods/service provider 180 and/or the service provider 190, including, e.g., safety information, consumer satisfaction survey information, complaint history, available products or services, future products or services, pricing information, available options, or the like.

Further, referring to FIG. 1, a user may complete payment, provide a promise to pay, provide information, provide ratings, provide feedback, or perform other functions through the SOSS 100 using the UCI 110. In the case of payment for transportation, for example, the user may enter a price, a tip and/or any other charges using the UCI 110. A users payment or other activity may be associated with a particular goods/service provider 180 or service provider 190 by associating the payment or other activity with a reservation or a procurement request. For example, the OSSC 160 may receive data identifying the goods/service provider 180 or service provider 190 from the UCI 110, or by receiving proximity data (e.g., GPS, Bluetooth, etc.) from the UCI 110 and the goods/service provider 180, and/or the service provider 190, or any other methodology that is capable of associating a particular user (UCI 110), a particular goods/service provider (180 and/or 190), a particular transaction, and the like, without departing from the scope and spirit of the disclosure.

Accordingly, the OSSC 160 may recognize the goods or service being paid for by the user (UCI 110), and the OSSC 160 may identify how to allocate the payment or perform other functions. For example, within a taxi fleet dispatch system, the OSSC 160 may identify an individual driver (service provider 190) associated with the ride and ensure payment to that driver. The OSSC 160 may also send a message to a device (not shown) in a service vehicle (service provider 190) to alert the driver that a payment has been made. The message may be provided as, e.g., an email message, a text message, an instant message, or the like, on a display (not shown) in the service vehicle 190, or as a sound message, a voice call message, or the like, provided on a sound communication device (not shown) in the service vehicle 190. The driver may be provided with an opportunity to decline the payment, recommend a different payment amount, provide feedback, provide ratings, provide information, or perform other functions through an interface device (not shown) in the service vehicle 190, or on the driver's person. The interface device may be similar to the UCI 110 disclosed herein. The OSSC 160 may collect information from the user (UCI 110), such as, for example, a service rating, a price negotiation, or other information. Once a payment, feedback or other function has been completed, the OSSC 160 may create a record, or update an existing record for the user and/or transaction and initiate processing, management, cashiering, reconciliation or other processes, as appropriate.

FIG. 3 shows an example of an SOSS process 300, according to the disclosure.

Initially, goods or services may be searched on, e.g., the Internet using the UCI 110 (shown in FIG. 1). Additionally (or alternatively) the searches may be conducted using the UCI 110 as an interface to the OSSC 160, which may conduct the searches on behalf of the UCI 110 through, e.g., the search engine 210 (shown in FIG. 2), and/or or referencing one or more index tables of service providers 190 or goods/service providers 180, which may be stored in the OSSC 160 or in any one or more of the databases 170. For example, the searches may be conducted on the information stored in the databases 174, 176, which may be indexed by the index tables of goods/service providers 180 or service providers 190.

After the user receives the search results on the UCI 110, the user may select certain goods or services from the results using the UCI 110 and communicate associated selection data to the OSSC 160, including user selection data (step 312). For example, when creating a ground transportation reservation, the user, after receiving information about a trip the user would like to take, may enter an origin location, a time of departure, a destination location, or the like using the UCI 110.

The OSSC 160, upon receiving the user selection data (step 312), may query the user profile and account database 172 for a record (or file) associated with the particular UCI 110 (or the particular user using the UCI 110) (step 314). The record that may be returned by the database 172 (step 316) may include identification information for the particular user (or UCI 110), such as, for example, a name, a business address, a home address, a business telephone number, a home telephone number, a mobile telephone number, a URL address, an email address, a bank account number, a bank routing number, a social security number, an authorization level, and the like. The record may further include one or more rules, such as, for example, but not limited to, a preferred means of travel (e.g., air, water, or ground), a preferred type of vehicle (e.g., a taxi, a rental car, a limousine, a bus, a train, a boat, a hover craft, a ship, a jet, a commuter airplane, a propeller airplane, a helicopter, or the like), a preferred type of lodging (e.g., a hotel, a motel, a rental apartment, a rental house, a tent, a recreational vehicle, or the like), and the like. The rules may be edited, deleted, or supplemented with additional rules by, e.g., an administrator at the site (or remotely) of the OSSC 160, by the user through the UCI 110, or by a third party, such as, e.g., an employer of the user, depending on the permission-level granted to the particular user, the administrator or the third party.

For example, a user who has been given administrative privileges may add rules, delete rules, or edit rules to the user's profile information in the database 172. Meanwhile, a user who has been given limited privileges may be granted permission to only view the rules in the user's profile information in the database 172.

Further, an artificial intelligence (Ai) engine (such as, e.g., a fuzzy logic, a neural network, or the like) may be included in the account management engine 270 (shown in FIG. 2), which may track historical information for each user, learn behavioral patterns for the user and customize the rules for the user based on the historical information and behavioral patterns.

It is noted that the user may select certain goods or services without conducting a search, since the user may, e.g., elect to use historical transaction data, which may be stored in the database 172 and/or the UCI 110. For example, a user may simply pull up a past transaction record using the UCI 110 and rebook the same transaction. Moreover, a short-cut may be created on the UCI 110 to rebook the transaction with a single selection.

Based on the received selection data (step 312) and the associated record(s) (step 316), the OSSC 160 may search, e.g., the database 174 of goods/service providers 180 or the database 176 of service providers 190 (step 318) to identify potential goods, goods providers, and/or goods provider options, or to identify potential services, service providers and/or service provider options based on resulting goods/services data received from the databases 174, 176 (step 320).

For example, if the user entered an origin location and a departure time (step 312), the OSSC 160 may search for service providers in the database 176 (step 318) or in a local index table to identify potential service providers 190 and/or service provider options (step 320). Similarly, the OSSC 160 may search for goods/service providers 180 in the database 174 (step 318) or in the local index table to identify potential goods/service providers and/or goods/service provider options (step 320).

The OSSC 160 may then determine any or all options that may apply, along with an estimate of a price for the options, and any information that may be useful to the user in selecting a particular option(s), including, e.g., user ratings, user feedback, consumer reports, expert reports, time of delivery, inventory, resources, or the like (step 322). An option may include, for example, but is not limited to, advanced services (e.g., handicapped access, luxury service, multiple stops, package delivery, dry cleaning, room service, dog walking, baby sitting, childcare, entertainment, wakeup calls, or the like), related goods (e.g., particular inventory for a hotel room refrigerator, souvenirs, or the like).

Further, before communicating the goods/service data (e.g., goods or service provider identification information, goods or services to be provided, delivery information, cost information, available options, cost of options, delivery information concerning options, and the like) to the UCI 110 (step 324), the OSSC 160 may apply the rules obtained for the particular user (or UCI 110) from the profile and account database 172 to filter the available goods/service providers 180, service providers 190, goods or services offered by the goods/service providers 180 or service providers 190, including certain options related to the available goods or services. For example, a company or other entity may only want its employees or members who are above a certain seniority to use, for example, a limousine service or a private jet service. Likewise, the company or other entity may not want very senior persons to be offered, for example, a shared ride option or a low-end rental car as part of a result to a search for travel services. Additionally, the company or other entity may want to calibrate access to goods or services based on, e.g., the price of the goods or services. The OSSC 160 may augment or limit the options communicated to the UCI 110 according to the rules provided in the record(s) for the particular user (UCI 110). Options data that is associated with the options which are determined to be applicable and proper for the particular user may then be communicated to the UCI 110 as, e.g., goods/services information (step 324).

After receiving the goods/services information from the OSSC 160 (step 324), the user may select certain (or all) of the options using the UCI 110 (step 326). The UCI 110 may then communicate the option selection data to the OSSC 160 (step 328). For example, the user may select an option to request a reservation with a particular service provider 190 along with a delivery of goods from a particular goods provider 180.

The OSSC 160, after receiving the option selection data (step 328), may communicate a goods/services request to a goods provider 180 and/or a service provider 190 (step 330), depending on the particular user selections. The OSSC 160 may ensure that the goods/service requests (step 330) are delivered to the appropriate goods providers 180 and/or service providers 190 at a time and in a manner that would best facilitate delivery of the goods and/or services.

For example, if the OSSC 160 received a booking request for transportation from the UCI 110 (step 312), the OSSC 160 may search for a service provider 190 (step 318) to determine whether an advance reservation can be made with a particular service provider 190. The search for the service provider 190 may be based on one or more rules in the profile associated with the particular user (or UCI 110). If an advance booking reservation cannot be made with a particular service provider 190 at that time, the OSSC 160 may store the booking reservation locally or in a database 170 until it can be made. Once the booking can be made, the OSSC 160 may use, for example, an integrated electronic link, or other communication medium 195, to communicate the goods/service request (step 330) to the service provider 190. The service provider 190, upon receiving the goods/service request (step 330) may respond to the request by communicating a confirmation notice to the OSSC 160 (step 332). The confirmation notice may include, e.g., a confirmation of receipt of the goods/service request, acknowledgment of intent to deliver the goods and/or services requested, detailed information relating to the delivery of the goods and/or services requested, a request for further information regarding the particular user requesting the goods and/or service (such as, e.g., name, address, photographic identification, credit history information, criminal history, etc.) and the like. The OSSC 160 may relay the confirmation notice to the UCI 110 (step 334). The interchange of information between the OSSC 160 (or the UCI 110) and the service provider 190 may continue until an agreement is reached and the service provider 190 confirms an intent to deliver the requested service based on certain agreed terms and/or conditions.

Additionally, when creating a ground transportation reservation, the OSSC 160 may be provided with a remote control feature of an aspect of the goods provider 180 and/or service provider 190, such that the OSSC 160 may schedule a delivery for a particular good directly in a goods delivery system (not shown) of the goods/service provider 180 via the communications medium 189 (shown in FIG. 1), or create a reservation directly in a service reservation system (not shown) of the service provider 190 via the communications medium 195 (shown in FIG. 1).

The OSSC 160 may be configured to monitor and track, e.g., the ground (or air, or water) transportation system of the goods/service provider 180 and/or the service provider 190, to ensure timely delivery of the goods or service to the user, and to communicate tracking information to the UCI 110 (step 336). For example, if the goods/services request (step 330) includes a request for vehicular ground transportation, the OSSC 160 may monitor and track a particular vehicle 190 in a fleet of vehicles of the service provider 180 that has been tasked with providing the ground transportation to ensure that the service is timely delivered. The OSSC 160 may communicate tracking information (such as, e.g., estimated time of arrival, vehicle location, traffic conditions, or the like) to the UCI 110. For instance, if the service requested was a taxi ride (step 330), the OSSC 160 may monitor and track a particular taxi (service provider 190) to determine whether a failure, such as, e.g., a “rapid meter” (a driver accepting and then closing a ride without actually completing it) or other failure has occurred. The OSSC 160 may communicate the particular taxi's location, estimated time of arrival, the traffic conditions along the taxi's route, or the like. If a goods or service delivery is likely to fail, the OSSC 160 may, e.g., communicate with the goods/service provider 180 to dispatch another vehicle (service provider 190). Accordingly, the OSSC 160 may ensure that requested goods and/or services are received by the intended recipient, which may be the user that originally requested the goods and/or services, or someone else.

Further, OSSC 160 may manage communication with the UCI 110, the goods/service provider 180 and/or the service provider 190 to initiate an intervention where necessary, and to manage aspects of the user's experience, including, but not limited to, e.g., finding goods/services, selecting goods/services, selecting options related to the goods/services, procuring the goods/services, delivering the goods/services, paying for the goods/services, documenting the transactions, and the like.

The user may elect to pay for the goods or services by, e.g., entering a payment amount, a tip amount, a promise to pay, or the like, using the UCI 110, which may then communicate the entered data to the OSSC 160 (step 338). The OSSC 160 may process the received data and provide payment to the goods/service provider 180 through the communication medium 189 and/or a confirmation notice, which may include other information, to the service provider 190 through the communication medium 195 (step 340). The user may also communicate other information to the OSSC 160, the goods/service provider 180 and/or the service provider 190 using the UCI 110, including information, such as, for example, feedback information, answers to a survey questionnaire, suggestions, recommendations, responses to requests for further information from the goods/service provider 180 and/or service provider 190, or the like.

After payment has been received by the goods/service provider 180 and/or the service provider 190 (step 340), a payment confirmation message may be sent to the OSSC 160 and the UCI 110 (step 345). Alternatively, the payment confirmation message may be sent to only one of the OSSC 160 or the UCI 110. Further, the payment confirmation message may be created by the OSSC 160 and sent to the UCI 110. The payment confirmation message may include information relating to a particular transaction associated with the payment, such as, e.g., expense documentation data and the like.

According to an aspect of the disclosure, as part of the processing, cashiering, reconciliation and other processes, the OSSC 160 may pass payment, tallies, or other deliverables to the goods/service provider 180 and/or the service provider 190. For example, in the case of a taxi ride, a payment may be made with an indication of a particular service provider 190 and a driver to whom the money is owed, ratings apply, or other information should be associated. The OSSC 160 may generate an electronic receipt or other documentation and make it available to the user, the user's organization, or others. The electronic receipt or other documentation may be delivered through many means, including, for example, an email, various types of downloads, directly inserted into an expense management system, or the like. By correlating key data points, the OSSC 160 may create a verifiable, trusted receipt that, for example, may be made tamper-proof and that may be inserted directly into an expense report or other expense verification system, and/or used to generate a tamper-proof, printable electronic document. This document may be made to look exactly like an actual paper receipt or other type of documentation, allowing it to be easily managed and reproduced or other functions to be performed.

Additionally, the OSSC 160 may log any user feedback, any statistics available relating to a particular user, goods/service provider 180, service provider 190, a particular transaction, or the like, to maintain user profiles, goods/service provider profiles, service provider profiles, transactional profiles, or the like. In this regard, the OSSC 160 may collect user feedback, recommendations, ratings, or the like, from the UCI 110 relating to a particular good or service and provide this information to future users. This information may be included, for example, among the information presented to a user when procuring a good or a service, or it may be used for the purposes of pricing, for negotiations, or the like. For example, statistics, such as those relating to completed trips, user ratings or empirical pricing for a sedan company may be presented to users seeking transportation options.

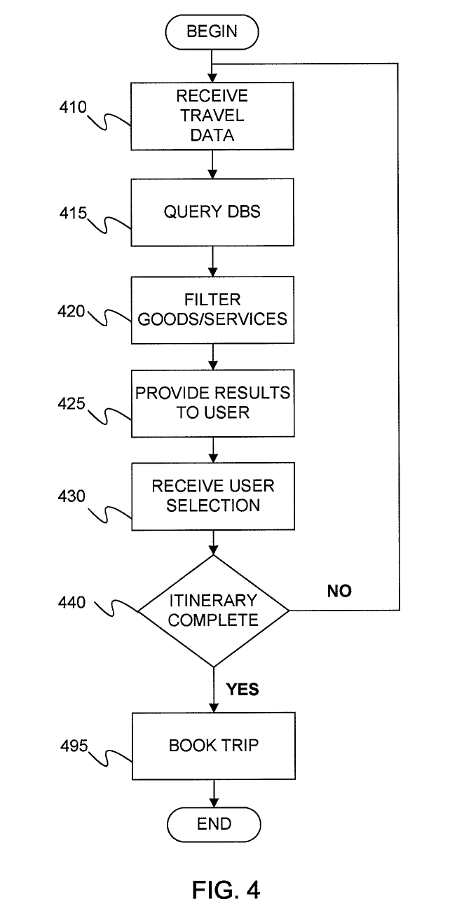

FIG. 4 shows an example of an itinerary builder process that may be used with the SOSS 100 system and the SOSS 300 process, according to the disclosure. In particular FIG. 4 shows an example of an itinerary builder process that may be used in searching for goods and/or services related to, e.g., travel, or to receive and display, build and manage, and/or request changes to a full itinerary, including air, hotel, rail, rental car, dining, entertainment and transportation. The itinerary builder process may be partially or entirely carried out on the UCI 110, the OSSC 160, or a combination of the UCI 110 and the OSSC 160.

After a user has selected an itinerary function for procuring goods and/or services, travel data is received for the particular user (step 410). The travel data may be entered to the UCI 110 by the user in real time, or it may be loaded from a record for a prior trip (such as, e.g., from information contained in a record in the database 172, which is associated with the particular user or UCI 110), or it may be loaded from a previous session, where the travel data may have been partially or completely entered, or it may be loaded from a bulk file, or the like. The travel data may include, for example, an origination location, a destination location, a departure time from the origination location, an arrival time at the destination location, and the like.

Based on the received travel data (step 410), the databases 170 may be queried to identify possible goods and/or services (step 415). The identified goods and/or services may be filtered based on the user's profile, to provide selection options for goods and/or services that meet predetermined rules (step 420). The selection options for the goods and/or services may then be communicated to the user (step 425), who may select certain of the goods and/or services. The selection options for the goods and/or services may be communicated to the user's device (e.g., the UCI 110, shown in FIG. 1) and automatically populated into the user's itinerary. Accordingly, the user may use additive selection for the available goods and/or services, or subtractive selection of selected goods and/or services from the populated itinerary.

The user's selections may be received (step 430) and a determination may be made as to whether the itinerary for the particular trip is complete (step 440). If it is determined that the itinerary is complete (YES, step 440), then the trip may be booked (step 445), otherwise the process may return to receive further travel data from the user (step 410).

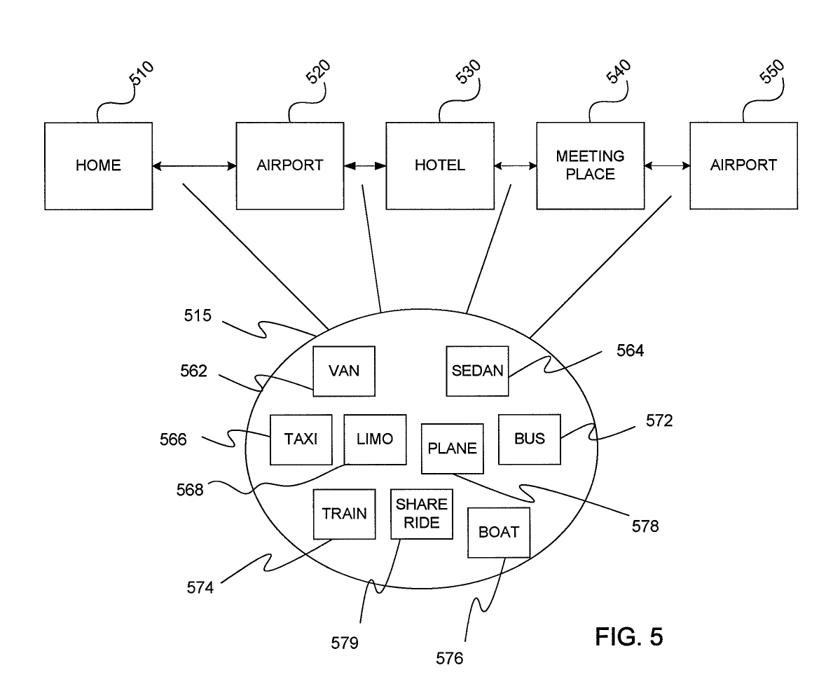

An illustrative example of an application of the itinerary builder process is shown in FIG. 5, according to the disclosure. As seen in FIG. 5, a user may, for example, enter the user's home location 510 as the origination location and the meeting place (or location) 540 as the destination location. The airports 520, 550 and/or the hotel 530 may be additively selected by the user from a plurality of goods/service options provided to the user, or automatically populated into the itinerary. The user may be provided with a matrix of options across different types of options, such as, e.g., a choice of airline carriers, a choice of hotels, a choice of first-class seating, business class-seating, economy seating, or the like, a choice of a meeting room, a room, a suite, or the like, or other goods/services related to the particular trip.

Further, the user may be provided with a plurality of options for transportation (515) between the home location 510 and the airport 520, between the airport 520 and the hotel 530, between the hotel 530 and the meeting location 540, and/or between the meeting location 540 and the airport 550, and the like. The options may be provided together with, e.g., pricing information regarding each option. Further, the options may include, but are not limited to, for example, parking, rental cars, entertainment, air taxi, boats, cruises, meals, lodging, collaboration, public transportation, incidentals, trains, shared services, financial services, or the like.

The plurality of options for transportations (515) may include, but are not limited to, for example, a van 562, a sedan 564, a taxi 566, a limousine 568, a bus 572, a train 574, a boat 576, a plane or a jet 578, a shared ride 579 (such as, e.g., a SuperShuttle, or private transportation), or the like.

It is noted that each of the communication medium disclosed herein may include a wired communication link, a wireless communication link, an optical communication link, or any combination thereof, without limitation. Further, each of the communication medium may include an integrated secure electronic link.

The networks disclosed herein may include, but are not limited to, for example, any one or more of a personal area network (PAN), a local area network (LAN), a campus area network (CAN), a metropolitan area network (MAN), a wide area network (WAN), a broadband network (BBN), the Internet, or the like. Further, the networks may include, but are not limited to, for example, any one or more of the following network topologies, including a bus network, a star network, a ring network, a mesh network, a star-bus network, tree or hierarchical network, or the like. The network may use a wired, a wireless, or a combination of wired and wireless communication media.

Further, each of the mobile computers disclosed herein may include, but are not limited to, for example a portable machine, device, circuit, component, or module, or any system of machines, devices, circuits, components, modules, or the like, which are capable of receiving and/or sending data, and which are further capable of manipulating data according to one or more instructions, such as, for example, without limitation, a processor, a microprocessor, a central processing unit, a general purpose computer, a personal computer, a laptop computer, a palmtop computer, a notebook computer, or the like, or an array of processors, microprocessors, central processing units, general purpose computers, personal computers, laptop computers, palmtop computers, notebook computers, or the like. For example, the mobile device may include, without limitation, a smart telephone, a cellular telephone device, a satellite telephone device, a cordless telephone, a software-defined-radio (SDR), a two-way radio, a personal data assistant (PDA), a game console, a game controller, an airport kiosk, a hotel kiosk, a bus terminal kiosk, or the like.

Still further, each of the computers disclosed herein may include, but are not limited to, for example, a mobile computer, a machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a personal computer, a laptop computer, a palmtop computer, a notebook computer, a desktop computer, a workstation computer, a server, or the like, or an array of processors, microprocessors, central processing units, general purpose computers, personal computers, laptop computers, palmtop computers, notebook computers, desktop computers, workstation computers, servers, supercomputers, or the like.

Still further, each of the transceivers disclosed herein may include one or more modems, including, e.g., without limitation, a hard-line connection modem, such as, e.g., a dial-up modem, an ISDN modem, a DSL modem, a cable modem, a fiber optic modem, a power-line modem, or the like; or a wireless modem, such as, e.g., a Wi-Fi modem, a Bluetooth modem, a DECT modem, WiBro modem, a WiMAX modem, a UMTS-TDD modem, a HSPA modem, an EV-DO modem, a Satellite modem, an IR modem, or the like.

The SOSS system and process provided herein gives a user, such as, e.g., a traveler, an ability to manage a variety of on demand and scheduled services, such as, e.g., transportation, lodging, goods or services associated with transportation or lodging, and the like, without limitation. The transportation may include, for example, a taxi, a limousine, a motorcycle, a bicycle, a scooter, a jet ski, a recreational vehicle, a truck, a bus, a train, a plane, a shared ride, a rental car, a boat, a ship, and the like. The lodging may include, for example, a recreational vehicle, an apartment, a condominium, a garden apartment, a house, a motel, a hotel, a campground, a tent, and the like, without limitation. The goods or services associated with transportation or lodging may include, for example, parking, entertainment, tolls, a driver, catering services, equipment, and the like.

Further, using the SOSS system or process disclosed herein a user, such as a traveler, can compare options, procure, document and rate travel and other goods or services in areas such as, but not limited to, ground transportation (e.g. taxi, sedan, shared ride, etc.). The user may use mobile devices, computers, the Internet and local applications, or other electronic means to effect the delivery of the services and interact with users and suppliers. As part of the procurement process, the user may make a payment or promise to pay for goods or services and perform other functions electronically. Verification that a payment has been made, reconciliation, pricing negotiations and other management activities related to the goods or services will be effectively and efficiently provided. A user may be provided with related services, such as, e.g., navigation, shopping, social, and entertainment management functionality, including, but not limited to, procuring convenient parking, reserving a rental car, booking on demand transportation (e.g. taxi, sedan, shared ride, air travel, water transport etc.) or arranging shared transport, booking/procuring tickets or other goods, reserving for/ordering/purchasing meals, inviting attendees or gathering input, etc.

It is noted that many changes can be made without departing from the spirit and scope of the disclosure and therefore would represent additional embodiments not presented herein.

For example, procurement, orders, reservation creation or other functions may be done for a wide array of goods, services, information or other needs (for example, movie tickets, payment for parking, payment for public transportation, restaurant reservations and payment, food delivery, air transport, etc.). The procurement, orders, reservation creation or other functions may be completed on a mobile application or by other means (for example, through a website, through IVR, etc.). In addition to a mobile application hosted on a mobile device, a mobile application may include, e.g., a mobile WAP application, a system for sending and receiving SMS, email or other messages to/from a mobile device, an integrated voice recognition (IVR) system or other voice system, or the like. Procurement, orders, reservation or other options may be presented with a wide set of information for making comparisons including user ratings, user comments, information from providers, information gathered, or other relevant information. Options offered may include a wide array of alternatives. For example, on-demand ground transportation alternatives to taxi or sedan rides may include rental cars, public transportation, membership programs for rides, parking options, shared rides, etc.

Further, where no options are available for procurement, reservation or other options, the options presented may include information about goods or service providers that could meet the needs of the user, such as, for example, in ground transportation, services in the area, or alternative transportation types.

Communication with the user may be achieved in many ways, including, but not limited to, for example, information displayed on the UCI 110 (FIG. 1), a website application, an SMS message sent to UCI 110, an email or other electronic message, a voice message over the phone or computer, a call center or live communication, or the like. Mobile communication may be achieved in many ways, including, without limitation, a system for sending and receiving SMS or email messages to/from a mobile device, a mobile WAP, an integrated voice recognition (IVR) system, a call center or live communication, a voice message over the phone or computer, or the like.

Payment processing and other functions may be achieved in many ways, including, without limitation, for example, passing charge data to a payment processor to process the credit/debit card or other payment forms, passing charge data directly to a goods or service provider for processing, creating a closed-loop e-commerce system between users/their organizations and goods or service providers, allowing negotiation, disputes, reconciliation and other capabilities as well as allowing users to review rates, invoices and payments to be made before either manually initiating transfer or automatically initiating funds or other transfers, direct funds transfer, bartering systems, tallies/accounts, or bi/multi-lateral reconciliation means, or the like.

Payment confirmation or other messaging for an operator or goods or service provider may be achieved in many ways, including, without limitation, for example, information sent to a device in the vehicle, for example, an in-car mobile data terminal, an SMS, email or other message sent to a mobile device or other device, a message sent to an application downloaded to a mobile device, a message sent to other in-vehicle or on-site device, an email or other electronic message, or the like.

While the disclosure has been described in terms of example embodiments, those skilled in the art will recognize that the invention can be practiced with switchable modifications in the spirit and scope of the appended claims. These examples given above are merely illustrative and are not meant to be an exhaustive list of all possible designs, embodiments, applications or modifications of the disclosure.

What is claimed is:

1. A system for providing a user with an ability to manage an on-demand or scheduled service, the system comprising:
a mobile communicator configured to receive instructions from the user and to send user data; and
a facilitator configured to receive the user data and to retrieve options data based on the user data,
wherein the facilitator is further configured to:
filter the options data based on an identification data,
provide associated costs and relevant information for the filtered options data, and
send the filtered options data and the associated costs to the mobile communicator.

2. The system of claim 1, wherein the identification data is one of a user identification data or a mobile communication device identification data.

3. The system of claim 1, wherein the facilitator is further configured to receive option selection data from the mobile communicator and send a request to a provider.

4. The system of claim 3, wherein the facilitator is further configured to receive a confirmation notice from the provider.

5. The system of claim 3, wherein the facilitator is further configured to send a confirmation notice to the mobile communicator.

6. The system of claim 1, wherein the facilitator comprises at least two of:
a search engine including selection rules;
a pricing engine configured to determine cost information based on the options data;
a payment processing engine configured to process a payment or a promise to pay;
a documentation engine configured to provide documentation information;
a cashiering engine configured to total an amount due for a transaction, charge the user for the amount due and collect payment for the transaction;
a reconciliation engine configured to compare multiple records and to ensure that a charge associated with the transaction matches an actual cost for the transaction;
an account management engine configured to manage account information, including a user profile, a goods provider profile, or a service provider profile; or
an expense management system engine configured to provide direct or indirect processing, payment, and auditing of user-initiated expenses.

7. The system of claim 1, wherein the mobile communicator is further configured to communicate price comparison information to the user, the communicator comprising:
a search engine including selection rules; and
an interface configured to receive an instruction from the user.

8. The system of claim 1, wherein the facilitator is further configured to automatically reserve a service based on the received user data.

9. The system of claim 8, wherein the service includes a travel service, the travel service comprising at least one of a taxi, a sedan, a chauffeured hourly limousine, a shared ride, a shuttle bus, a rental car, a parking or a flight.

10. The system of claim 7, wherein the pricing comparison information comprises pricing between travel goods and service options selected from different service types.

11. The system of claim 10, wherein the different service types comprise:
ground transportation;
water transportation; and
air transportation.

12. The system of claim 7, wherein the price comparison information comprises at least one of an availability, a type, a cost, a user rating or a recommendation regarding a good or a service.

13. The system of claim 1, wherein the mobile communicator further comprises an itinerary builder configured to build and manage a full itinerary, including receive and display, build and manage, or request changes to a full itinerary, including air, hotel, rail, rental car, dining, entertainment and ground transportation, goods and service types, and appointment plans.

14. The system of claim 5, the confirmation notice including a confirmation of a scheduling of a delivery of a good or a service by the provider.

15. The system of claim 1, wherein the facilitator is further configured to apply a corporate rule to a good or a service option.

16. The system of claim 8, wherein the facilitator is further configured to automatically reserve the service without prepaying for a good or a service.

17. The system of claim 8, wherein the facilitator is further configured to accurately prepay for a good or a service.

18. The system of claim 7, wherein the instruction comprises an instruction to pay for a good or a service substantially immediately after completion of delivery of the good or the service.

19. The system of claim 7, wherein the instruction comprises an instruction to pay for a good or a service received during delivery of the good or the service.

20. The system of claim 3, wherein the facilitator is further configured to provide payment verification information to the provider without communicating sensitive information, the sensitive information comprising at least one of a credit card number or a physical signature.

21. The system of claim 1, wherein the facilitator is further configured to electronically document at least one of an amount paid, an amount owed, or an amount used.

22. A method for providing managing an on-demand or scheduled service, the method comprising:
receiving user data from a mobile communicator;
retrieving options data based on the user data;
filtering the options data based on an identification data;
determining associated costs for the filtered options data; and
sending the filtered options data and the associated costs to the mobile communicator.

23. The method of claim 22, wherein the identification data is one of a user identification data or a mobile communication device identification data.

24. The method of claim 22, further comprising:
receiving option selection data from the mobile communicator; and
sending request data to a provider.

25. The method of claim 24, further comprising:
receiving a confirmation notice from the provider.

26. The method of claim 24, further comprising:
sending a confirmation notice to the mobile communicator.

27. The method of claim 22, further comprising:
searching for a good or a service based on the user data, wherein the searching is based on selection rules;
retrieving information relating to the good or the services from at least one provider;
determining cost information associated with the good or the services; and
providing pricing information to the mobile communicator, the pricing information being based on the determined cost information.

28. The method of claim 27, further comprising:
receiving at least one of a goods request, a service request or an option request from the mobile communicator;
reserving delivery of the good or the service from the at least one provider based on the at least one of the goods request, the service request or the option request;
determining an amount due for the good or the service;
charging a user account for the amount due; and
collecting payment from the user account.

29. The method of claim 28, further comprising:
processing a payment or a promise to pay; and
documenting at least one of the amount due, the charging the user account and the collecting payment from the user account, the documenting comprising generating documentation information.

30. The method of claim 29, further comprising:
comparing multiple records to ensure a charge associated with the amount due matches an actual cost for the goods or the service.

31. The method of claim 22, further comprising:
managing account information, including a user profile, a goods provider profile or a service provider profile.

32. The method of claim 22, further comprising:
providing direct or indirect processing, payment and auditing of user-initiated expenses to an expense management system.

33. The method of claim 28, wherein the service includes a travel service, the travel service comprising at least one of a taxi, a sedan, a chauffeured hourly limousine, a shared ride, a shuttle bus, a rental car, a parking and a flight.

34. The method of claim 27, wherein the pricing information comprises comparison pricing between travel goods and service options selected from different service types.

35. The method of claim 34, wherein the different service types comprise:
ground transportation;
water transportation; and
air transportation.

36. The method of claim 27, wherein the pricing information comprises at least one of an availability, a type, a cost, a user rating or a recommendation regarding the good or the service.

37. The method of claim 22, further comprising:
building an itinerary, including ground transportation, a good or a service type, and an appointment plan.

38. The method of claim 22, further comprising:
confirming a scheduling of delivery of a good or a service by a provider.

39. The method of claim 22, wherein the filtering comprises applying a corporate rule to a good or a service option.

40. The method of claim 28, wherein reserving the good or the service is performed without prepaying for the good or the service.

41. The method of claim 22, further comprising:
accurately prepaying for a good or a service.

42. The method of claim 22, wherein the user data comprises an instruction to pay for a good or a service substantially immediately after completion of delivery of the good or the service.

43. The method of claim 22, wherein the user data comprises an instruction to pay for a good or a service received during delivery of the good or the service.

44. The method of claim 27, further comprising:
providing payment verification information to the at least one provider without communicating sensitive information, the sensitive information comprising at least one of a credit card number or a physical signature.

45. The method of claim 22, further comprising:
electronically documenting at least one of an amount paid, an amount owed, or an amount used.

46. The method of claim 28, further comprising:
monitoring a status of the delivery of the good or the service; and
intervening when an error status is determined.

47. The method of claim 46, wherein the intervening comprises:
contacting the mobile communicator; or
contacting the at least one provider.

48. The method of claim 43, wherein the instruction is based on a GPS signal or a Bluetooth signal.
